(19) United States
(12) Patent Application Publication
(10) Pub. No.: US 2002/0139618 A1
(43) Pub. Date: Oct. 3, 2002

(54) Mechanism for providing motion and force while maintaining parallelism between a base structure and a movable structure

(76) Inventor: Kevin J. Anibas, Eau Claire, WI (US)

Correspondence Address: KEVIN J. ANIBAS, 2136 4th ST., EAU CLAIRE, WI, 54703, US

(21) Appl. No.: 09/822,083

(22) Filed: Apr. 2, 2001

(51) Int. Cl. B66F 7/06; B66B 11/08; B66B 9/02

(52) U.S. Cl. 187/211; 187/255; 187/263; 187/269

(57) ABSTRACT

This mechanism is designed to provide motion and force while maintaining parallelism between a base structure and a movable structure. This is accomplished by opposed pairs of pivoting arms which are synchronized by a timing device which links an arm with the arm opposite to it and ensures that these arms move the same distance but in opposite directions. This mechanism will work in any spatial orientation. Applications of this mechanism include lift tables, adjustable work stations, vertically adjustable conveyors, and others.

### CROSS-REFERENCE TO RELATED APPLICATIONS

Not Applicable

### STATEMENT REGARDING FEDERALLY SPONSORED RESEARCH OR DEVELOPMENT

Not applicable

### REFERENCE TO A MICROFICHE APPENDIX

Not Applicable

### BACKGROUND OF THE INVENTION

This invention applies to maintaining parallelism between a base structure and a movable structure as it applies to lifting devices, lift tables, adjustable workstations, and other applications where maintaining parallelism is necessary.

Currently available lift tables are most commonly actuated by a scissor mechanism featuring arms which pivot with a mating arm in the center of their length. One end of these arms is rotatably fixed to either the top structure or the base structure of the lift, and the other end is free to move along a plane parallel to the base and the movable surface. Because of the central pivot point, large bending forces are introduced into said arms. To maintain strength and safety, these arms and structures related to them must be made of sufficient quantities of strong materials, usually steel, which results in considerable weight. These lifts suffer reduced capacity as a result of having to lift this weight in addition to the load. These lifts generally are limited in length as the bending forces on the arms, and the energy required to move the arms, becomes impractically large at longer arm lengths. These lifts also suffer in terms of portability because their mass makes them difficult to move. Also due to this mass, these lifts need relatively larger actuation devices and more energy to operate. In some cases these devices can only operate vertically because they rely on gravity to maintain parallelism between the base and the movable structure.

### BRIEF SUMMARY OR THE INVENTION

This mechanism for providing force while maintaining parallelism between a base structure and a movable structure is comprised of opposed pairs of linked, rotatably mounted, support arms with a timing mechanism acting such that when one arm moves the arm opposite to it must move an equal distance in the opposite direction, thus ensuring that the base structure and the movable structure remain parallel to each other. Since the forces on these arms are purely compressive in nature, the arm's structure can be optimized for efficient use of materials and relatively light weight. The actuating device, a screw, pneumatic or hydraulic cylinder, cable, or other device is under tension when the device is loaded and can also be optimized for weight and safety.

### BRIEF DESCRIPTION OF THE SEVERAL VIEWS OF THE DRAWING

FIG. 1 shows a side view of the mechanism in an extended position.

FIG. 2 shows enlarged view of a sprocket fixed to a rotatably mounted arm, a chain segment, tension members, and a tensioning device as seen from the side.

FIG. 3 shows a side view of the mechanism in a retracted position.

FIG. 4 shows a side view of the screw and nut actuator assembly in an extended position.

FIG. 5 shows an enlarged view of the rotatable and pivotable screw to arm pivot mount.

FIG. 6 shows an enlarged view of the pivotable nut assembly to arm pivot mount.

FIG. 7 shows an end view of the mechanism.

FIG. 8 shows a bottom view of the mechanism.

FIG. 9 shows an enlarged view of a tensioner, tension members, and chain as seen from the bottom.

### DETAILED DESCRIPTION OF THE INVENTION

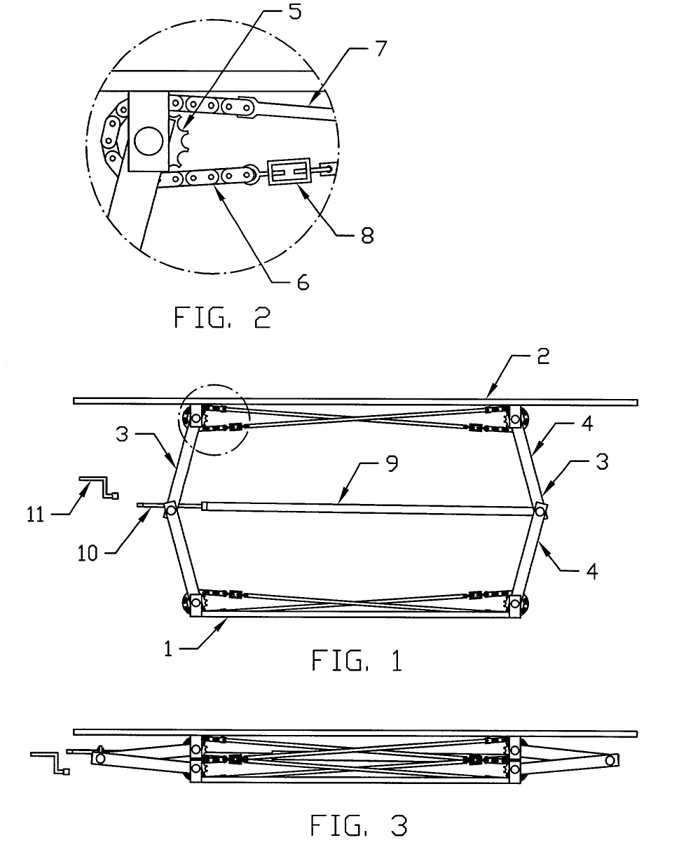

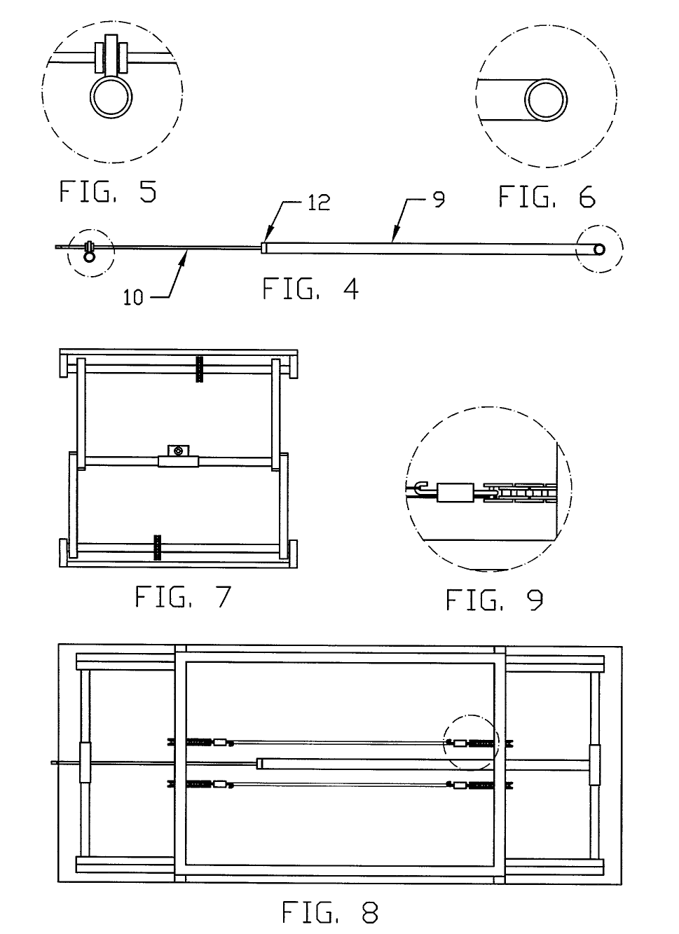

The mechanism consists of a base structure 1, a movable structure 2, opposed arm assemblies 3, a timing mechanism FIG. 1 and FIG. 2, and an actuation device 9. The arm assemblies 3, each consist of two arms 4, of equal length which are pivotably mounted to each other in the center of each arm assembly. Each of the arm assemblies is rotatably mounted to the base structure 1, at one end of the arm assembly and rotatably mounted to the movable structure 2, at the other end of the arm assembly. A sprocket 5, is fixed to each arm where the arm assembly is rotatably mounted to the base structure and rotatably mounted to the movable structure. A section of chain 6, is fitted over the sprockets. This chain 6, is joined in cross fashion to the chain adjacent to it by tension members 7, of sufficient strength to accommodate the expected loads including a factor of safety. Slack is removed from the system by the incorporation of an in-line turnbuckles or other tensioning devices 8. As the chains and tension members link the adjacent arms to each other in cross fashion, the arms must move equal distances and opposite directions from the arms opposite to them. Alternatively, the sprockets and chains can be substituted by gear belts and pulleys or notched pulleys and cables or the like. The mechanism is actuated by moving the arm assembly central pivot points toward or away from each other. This is accomplished by means of a screw 10, which is rotatably and pivotably mounted to one arm assembly pivot FIG. 5, acting on a mating nut assembly which is pivotably mounted to the pivot of the other arm assembly FIG. 6. Since the nut 12, is located on the end of the nut assembly, the screw need not extend the fill length from arm assembly pivot to arm assembly pivot. As the screw is turned, the arm assembly to arm assembly pivot points are pulled toward one another, and the movable structure is moved away from the base structure while remaining parallel to the base structure. Likewise, when the screw is turned the other direction, the arm assembly to arm assembly pivot points are moved away from one another, the movable structure is moved toward the base structure while remaining parallel to the base structure. The screw is turned with a hand crank 11, hand held drill, or by motor mounted on the arm assembly pivot. Alternatively, a pneumatic or hydraulic cylinder or cable and winch could be used as an actuation device in place of the screw.

What I claim as my invention is:

1. A mechanism for lifting and parallel motion which allows for lighter structures, more efficient use of materials, and requires less energy to operate than conventional scissor lift mechanisms.

2. A mechanism as in claim 1 for lifting and parallel motion which is practical at longer table lengths than lift tables with conventional scissor mechanisms.

3. A mechanism as in claim 1 for providing parallel motion which can operate in any spatial orientation.
